(19) United States
(12) Patent Application Publication
(10) Pub. No.: US 2011/0309639 A1
(43) Pub. Date: Dec. 22, 2011

(54) Latching Mechanism for Airtight Container

(76) Inventors: Dar-Zen Chen, Taipei City (TW); Fredrick Sun, Taipei City (TW); Tzong-Ming Wu, Taipei City (TW); Wen-Bin Shieh, Taipei City (TW)

(21) Appl. No.: 12/944,026

(22) Filed: Nov. 11, 2010

(30) Foreign Application Priority Data
Jun. 17, 2010 (TW) 099119715

(51) Int. Cl. E05C 1/08

(52) U.S. Cl. 292/140

(57) ABSTRACT

A latching mechanism for an airtight container includes a door body; a rotation element pivoting the door body, the rotation element rotating in a first rotation direction or a second rotation direction; a moving element moving outward or inward; a first push mechanism, wherein when the rotation element rotates in the first rotation direction, the first push mechanism makes the moving element move outward, and the first push mechanism includes a first guide slot situated at the rotation element; and a first guide block situated at the moving element, the first guide block sliding within the first guide slot; a pressing element situated at the door body; and a second push mechanism, wherein when the rotation element rotates in the first rotation direction, the second push mechanism pushes the pressing element such that the pressing element pushes the moving element upward.

### BACKGROUND OF THE INVENTION

1. Field of the Invention

The present invention relates to a latching mechanism, specifically to a latching mechanism for an airtight container which has high reliability and cleanliness.

2. Description of the Related Art

In the prior arts, it is necessary to have the function of latching and sealing a container for a latching mechanism for an airtight container (such as a wafer pod). However, during the latching and sealing motions, the members of the mechanism produce sliding friction against the surface of the latch of the container, which forms particles. These particles contaminate the clean containers or processing machines, thereby contaminating the contents (such as wafers or substrates) inside the airtight container and the chamber of the processing machines.

Furthermore, the latching mechanism needs to remain in the correct position. Therefore, during the conveyance process through different interfaces and systems, it is necessary to prevent the latching mechanism from loosening due to gravity or vibration. If the latching mechanism is loosened, the latching or sealing effect is reduced. Also, if the position of the latching mechanism is changed, it may not be aligned with the latch holes and the interface position of the loading/unloading machine. Therefore, improved technologies have been proposed to mitigate and/or obviate the aforementioned problems.

For instance, U.S. Pat. No. 5,915,562 discloses a latching mechanism used for latching the door body on the wafer pod, wherein a cam is situated at the center or on the two sides of the door body. Two cam slots are situated on the cam for each set of latching mechanisms, so as to drive an upper long link rod and a lower long parallel link rod that are parallel to each other, respectively. Both of the two long link rods have a contact incline. The position of one contact incline corresponds to that of the other contact incline.

Therefore, when the two long link rods are respectively driven by the two cam slots, the result is axial movements of the two long link rods, respectively. The relative movements of the two long link rods make the two contact inclines push onto each other and increase the distance between the two long link rods, so as to press the door body towards the inside of the wafer pod to increase its air-tightness.

However, the above U.S. Pat. No. 5,915,562 utilizes two cam slots and two long link rods. The number of rod members is increased, and the structure is complex. Furthermore, the long sliding distance of the two long link rods produces dust particles as a result of friction, which may contaminate the wafer pod and the wafer.

Moreover, U.S. Pat. No. 6,430,877 discloses a device that aligns the door body and the pod. The device increases the latching position accuracy of the door body of the wafer pod. Thus, during the open/close circulation process of the latch mechanism, the central position of the latching holes will not be changed by the weight of the door body of the wafer pod itself. U.S. Pat. No. 6,663,148 discloses an alignment device, too. The alignment device increases the latching position accuracy of the door body of the wafer pod. However, due to the vibrations during the conveyance and loading/unloading process, the prior arts disclosed above do not ensure that the latching mechanism will remain in the correct relative position. U.S. Pat. No. 6,880,718 discloses a spring device used for maintaining the latching mechanism in the desired position. This prevents the latching mechanism from moving out of the relative position due to gravity or vibrations during the conveyance and the loading/unloading process. The change of the relative position of the latching mechanism will change the position of the open/close interface for the loading/unloading machine. In order to prevent contamination from metallic dust particles, metallic elements are usually avoided in the applications of the wafer pod. Therefore, engineering plastic resins are used to produce the spring device. However, its springiness characteristic is difficult to maintain. Thus it fails to satisfy the high MCBF (Mean Cycles Between Failure) requirement of the reliability of the wafer pod in semiconductor industry.

Furthermore, Taiwan patent 534,165 discloses a latching mechanism for a door body of a wafer pod. The latching mechanism uses a cam to drive a link rod. A press plate pivots at the other end of the link rod. The press plate can slide along a translation guide slot and a curved path of a guide block. When the link rod is driven forward by the cam, the press plate slides into the inserting slot of the wafer pod. Next, the press plate slides along the curved path guide slot and rotates such that the front end of the press plate elevates and pushes onto the side of the inserting slot of the wafer pod. Through the translation motion and the rotational downward pressure, this two-stage operation exerts pressure on the door body of the wafer pod and forms an airtight seal. This invention can reduce the friction and the contact area between the link rods, thus preventing the resulting dust particles from contaminating the inside of the wafer pod. However, because of the structure's complexity, the quality and specification of the tolerance between the press plate and the curve of the guide block are difficult to control, thereby increasing production costs and technical difficulties.

Therefore, it is necessary to provide a latching mechanism for an airtight container with high reliability and cleanliness to mitigate and/or obviate the aforementioned problems.

### SUMMARY OF THE INVENTION

The main objective of the present invention is to provide a latching mechanism for an airtight container with high reliability and cleanliness. The latching mechanism for an airtight container can perform the latching function and the sealing function separately, simplify the structure, and significantly decrease sliding friction against the door body of the container. Moreover, it ensures the position of the latch of the mechanism and prevents the latch of the mechanism from loosening due to vibration during the process of conveyance, loading and unloading, and transportation.

In order to achieve the above objective, the latching mechanism for an airtight container comprises: a door body; a rotation element pivoting the door body, the rotation element rotating in a first rotation direction or a second rotation direction; a moving element moving outward or inward; a first push mechanism, wherein when the rotation element rotates in the first rotation direction, the first push mechanism makes the moving element move outward; the first push mechanism includes a first guide slot situated at the rotation element, and a first guide block situated at the moving element, the first guide block sliding within the first guide slot; a pressing element situated at the door body; and a second push mechanism, wherein when the rotation element rotates in the first rotation direction, the second push mechanism pushes the pressing element such that the pressing element pushes the moving element upward.

### BRIEF DESCRIPTION OF THE DRAWINGS

FIG. 1 is a schematic drawing of the whole of a latching mechanism for an airtight container of the present invention.

FIG. 2 is an exploded view of the latching mechanism for an airtight container of a first embodiment of the present invention.

FIG. 3 is a perspective view of the latching mechanism for an airtight container of the first embodiment of the present invention in an unlatched state.

FIG. 4 is a perspective view of the latching mechanism for an airtight container of the first embodiment of the present invention in a latched state.

FIG. 5 is an exploded view of the latching mechanism for an airtight container of a second embodiment of the present invention.

FIG. 6 is a perspective view of the latching mechanism for an airtight container of the second embodiment of the present invention in an unlatched state.

FIG. 7 is a perspective view of the latching mechanism for an airtight container of the second embodiment of the present invention in a latched state.

FIG. 8 is a perspective view of the latching mechanism for an airtight container of a third embodiment of the present invention.

FIG. 8A and FIG. 8B are detailed drawings illustrating a first contact element and a second contact element of the latching mechanism of an airtight container of the third embodiment of the present invention.

### DETAILED DESCRIPTION OF THE PREFERRED EMBODIMENT

The advantages and innovative features of the invention will become more apparent from the following detailed description when taken in conjunction with the accompanying drawings.

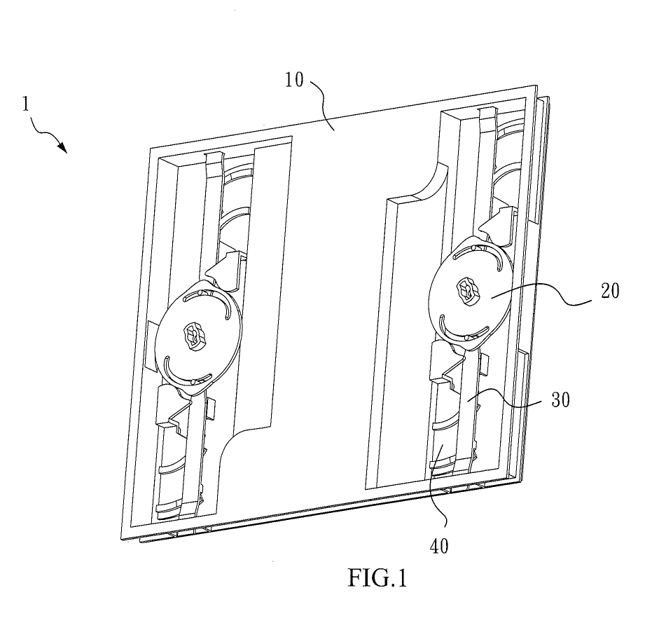

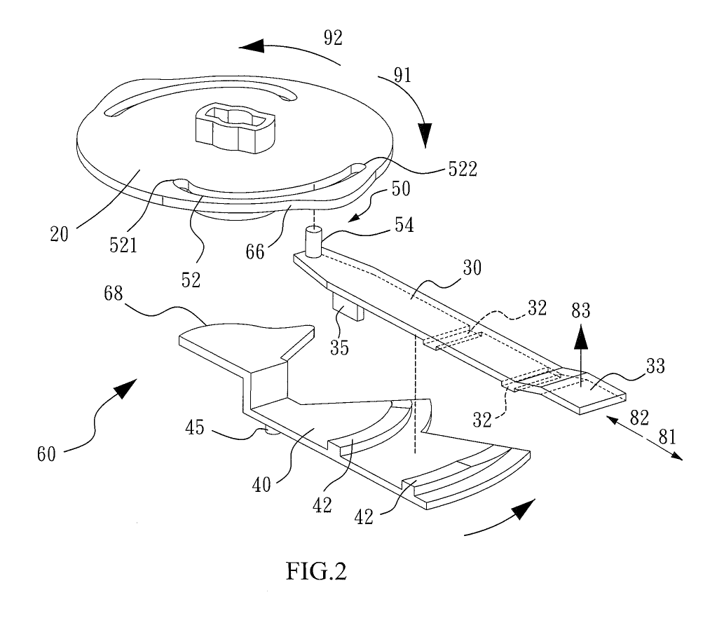

Please refer to FIG. 1, which is a schematic drawing of the whole of a latching mechanism for an airtight container with high reliability and cleanliness of the present invention. The latching mechanism for an airtight container 1 is used for fastening the airtight container (not shown).

An extremity 33 of a moving element 30 of the latching mechanism for an airtight container 1 shown in FIG. 1 does not extend beyond a door body 10. At this moment, the latching mechanism for an airtight container 1 is not yet fixed onto the airtight container. When the extremity 33 of the moving element 30 of the latching mechanism for an airtight container 1 extends beyond the door body 10 and exerts pressure around the airtight container, the latching mechanism for the airtight container 1 is fixed onto the airtight container and forms an airtight seal inside the airtight container. For instance, the airtight container can be a wafer pod, but the use of the latching mechanism for an airtight container of the present invention is not limited to this application.

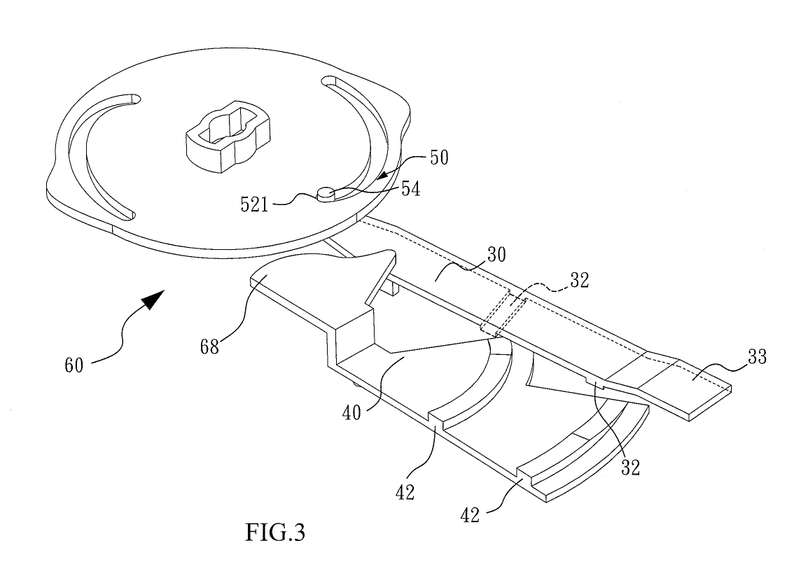

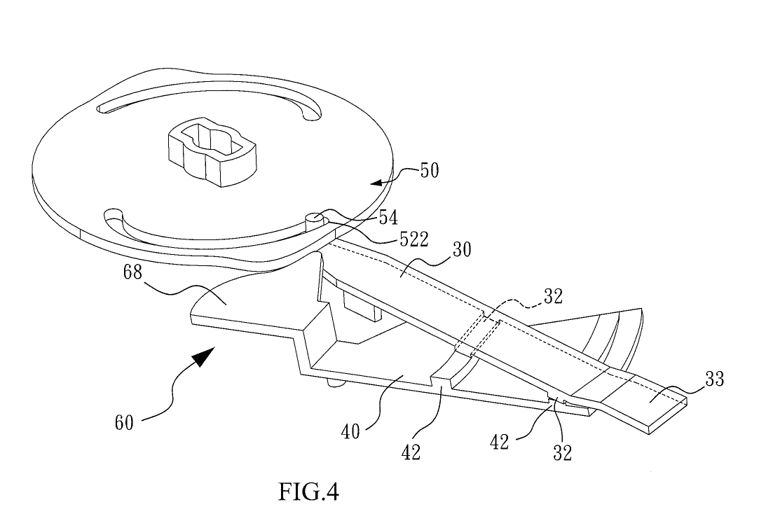

Next, please refer to FIG. 2 to FIG. 4, which illustrates the latching mechanism for an airtight container of a first embodiment of the present invention. FIG. 2 is an exploded view of the latching mechanism for an airtight container of the first embodiment of the present invention. FIG. 3 is a perspective view of the latching mechanism for an airtight container of the first embodiment of the present invention in an unlatched state. FIG. 4 is a perspective view of the latching mechanism for an airtight container of the first embodiment of the present invention in a latched state. For convenience, FIG. 2 to FIG. 4 only show one quarter of the latching mechanism for the airtight container 1 shown in FIG. 1. The rest has either the same or a symmetrical structure.

The latching mechanism for an airtight container 1 comprises the door body 10 (as shown in FIG. 1), a rotation element 20, the moving element 30, second contact elements 32, a first push mechanism 50, a pressing element 40, first contact elements 42, and a second push mechanism 60. The door body 10 is the main housing of the latching mechanism for an airtight container (as shown in FIG. 1) and is positioned on one of the sides of the airtight container. The other components are primarily situated at the door body 10.

The rotation element 20 pivots the door body 10. The rotation element 20 rotates in a first rotation direction 91 (clockwise) or a second rotation direction 92 (counterclockwise). In this embodiment, the outer edge of the rotation element 20 is not perfectly round. It has a flange.

Because the motion of the moving element 30 is restricted to a guide 35, it can only move in an outward direction 81 or an inward direction 82. The moving element 30 is in the form of a rod, for example. The second contact elements 32 are situated on the inner side of the moving element 30 and have a structure of an incline.

When the rotation element 20 rotates in the first rotation direction 91, the moving element 30 moves in the outward direction 81 due to the operation of the first push mechanism 50. In this embodiment, the first push mechanism 50 comprises a first guide slot 52 and a first guide block 54. The first guide slot 52 is situated at the rotation element 20. The first guide block 54 is situated at one end of the moving element 30. The first guide block 54 slides within the first guide slot 52. In this embodiment, the first guide slot 52 is an eccentric arc, and the first guide block 54 is a cylinder.

When the rotation element 20 rotates in the first rotation direction 91, the first guide block 54 slides within the first guide slot 52. A first end 521 of the first guide slot 52 is farther from the edge of the rotation element 20, and a second end 522 of the first guide slot is closer to the edge of the rotation element 20. Through the path guided by the first guide slot 52, the moving element 30 moves in the outward direction 81 when the first guide block 54 slides from the first end 521 (as indicated in FIG. 3) towards the second end 522 (as indicated in FIG. 4).

The pressing element 40 pivots the door body 10 via a pivot 45, which enables the pressing element 40 to rotate relative to the door body 10. The first contact elements 42 are situated at the pressing element 40. In this embodiment, the first contact elements 42 are elongated arc-shaped inclines. When pressing element 40 rotates to a certain region, the first contact elements 42 contact the second contact elements 32 and cause the second contact elements 32 to elevate.

When the rotation element 20 rotates to a certain region in the first rotation direction 91, the second push mechanism 60 pushes the pressing element 40, such that the first contact elements 42 situated at the pressing element 40 push the second contact elements 32 situated at the moving element 30 in an upward direction 83.

In this embodiment, the second push mechanism 60 comprises a protruded first track 66 and a protruded second track 68. The first track 66 is positioned at the edge of the rotation element 20, and the second track is positioned at the edge of the pressing element 40. When the rotation element 20 rotates to a certain region in the first rotation direction 91, the first track 66 contacts the second track 68 such that the pressing element 40 rotates. In this embodiment, the rotation direction of the pressing element 40 is opposite to the rotation direction of rotation element 20.

In this embodiment, the number of the first contact elements 42 is two. The number of the second contact elements 32 is two. The first contact elements 42 and the second contact elements 32 are wedge-shaped. However, the number of the first contact elements 42 and the number of the second contact elements 32 are not limited to this. The shape of the first contact elements 42 and the shape of the second contact elements 32 are not limited to this, either. A space exists between the first contact elements 42 and the second contact elements 32. The angles of the inclines of the two first contact elements 42 are the same, and the angles of the inclines of the two second contact elements 32 are the same. Therefore, when the pressing element 40 pushes the moving element 30 in the upward direction 83, the pressing element 40 and the moving element 30 are substantially parallel.

It should be noted that the shape and the number of the first contact elements 42 and the second contact elements 32 are not limited to the above description. For instance, if the number of the first contact elements 42 and the number of the second contact elements 32 are both one, when the pressing element 40 pushes the moving element 30 upwards, the pressing element 40 and the moving element 30 will not be parallel. An included angle will be formed.

The operation of this embodiment will be described below. When the latching mechanism of an airtight container 1 is in the position shown in FIG. 3, the rotation element 20 rotates in the first rotation direction 91. The first guide block 54 of the moving element 30 is guided by the guide slot 52, which causes the extremity 33 of the moving element 30 to move in the outward direction 81. At this moment, the extremity 33 of the moving element 30 extends to connect with the airtight container. The first track 66 does not contact the second track 68 yet, so the pressing element 40 does not move.

When the rotation element 20 rotates in the first rotation direction 91 to a certain angle, the latching mechanism of an airtight container 1 will be in the position shown in FIG. 4. The first track 66 contacts the second track 68, which causes the pressing element 40 to rotate counterclockwise. At this moment, the first contact elements 42 contact the second contact elements 32 such that the extremity 33 of the moving element 30 moves in the upward direction 83. The extremity 33 of the moving element 30 then exerts pressure on the airtight container in the upward direction 83, which forms an airtight seal in the airtight container.

It should be noted that the first rotation direction 91 and the second rotation direction 92 are not limited to the above description. For instance, if the arrangement of the latching mechanism of an airtight container 1 is symmetrical, the first rotation direction 91 can be a counterclockwise direction.

In addition, in the above embodiment, the motion of the extremity 33 of the moving element 30 in the outward direction 81 and that in the upward direction 83 do not occur at the same time. However, actually with only the modification of the structure of the first guide slot 52, the first track 66 and/or the second track 68, the extremity 33 of the moving element 30 can move in the outward direction 81 and in the upward direction 83 simultaneously, such that its motion is oblique motion.

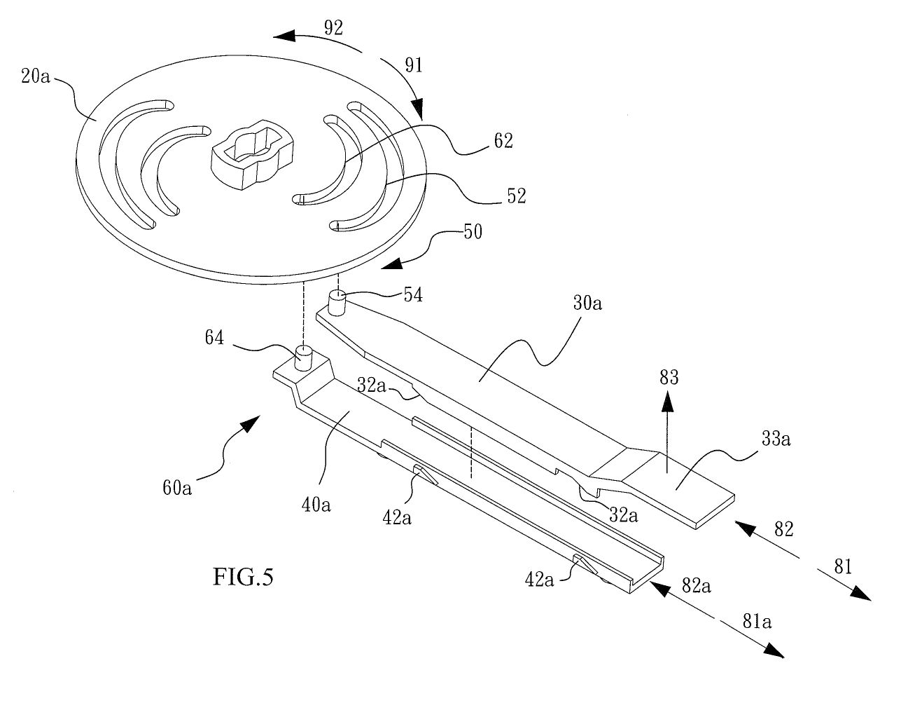

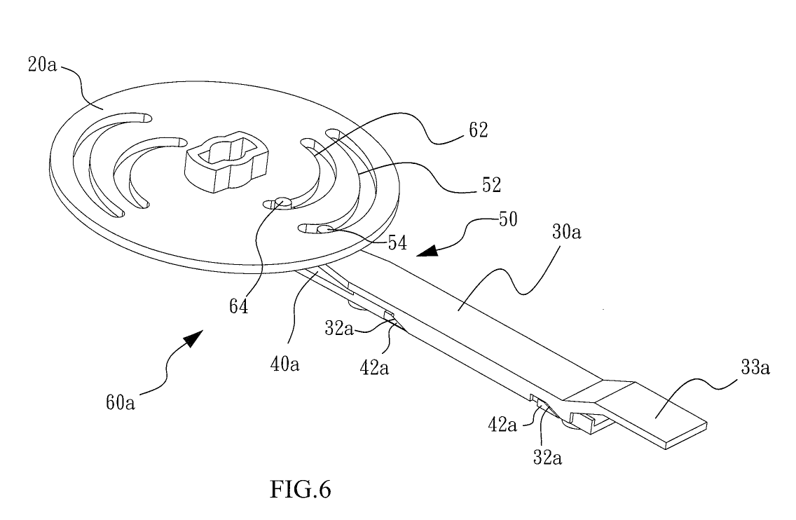

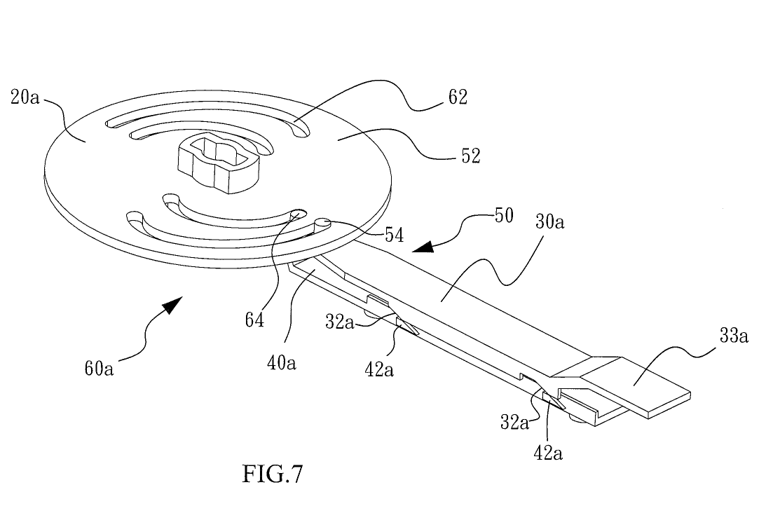

Please refer to FIG. 5 to FIG. 7, which illustrate the latching mechanism for an airtight container of a second embodiment of the present invention. FIG. 5 is an exploded view of the latching mechanism for an airtight container of the second embodiment of the present invention. FIG. 6 is a perspective view of the latching mechanism for an airtight container of the second embodiment of the present invention in an unlatched state. FIG. 7 is a perspective view of the latching mechanism for an airtight container of the second embodiment of the present invention in a latched state.

The latching mechanism of an airtight container 1a comprises the door body 10, a rotation element 20a, a moving element 30a, second contact elements 32a, the first push mechanism 50, a pressing element 40a, first contact elements 42a, and a second push mechanism 60a. In this embodiment, the structure and the way of operation of the first push mechanism 50 are the same of those of the first embodiment.

In this embodiment, the second push mechanism 60a comprises a second guide slot 62 and a second guide block 64. The second guide slot 62 is an eccentric arc. The second guide block 64 is a cylinder. The second guide slot 62 is situated at the rotation element 20a. The second guide block 64 is situated at the pressing element 40a. The second guide slot 62 is situated on the inside of the first guide slot 52. When the rotation element 20a rotates in the first rotation direction 91, the second guide block 64 slides within the second guide slot 62 such that the pressing element 40a moves in the outward direction 81a.

The second contact elements 32a are positioned on the two sides of the moving element 30a. The first contact elements 42a are positioned on the two sides of the pressing element 40a. The cross-section of the second contact elements 32a and the cross-section of the first contact elements 42a are substantially triangular or trapezoidal.

The operation of this embodiment will be described below. When the latching mechanism of the airtight container 1a is in the position shown in FIG. 6, the rotation element 20a rotates in the first rotation direction 91. The first guide block 54 of the moving element 30a is guided by the first guide slot 52, which causes the extremity 33a of the moving element 30a to move in the outward direction 81. At this moment, the extremity 33a of the moving element 30a extends to connect with the airtight container. Next, the second guide slot 62 pushes the second guide block 64 such that the pressing element 40a also moves in the outward direction 81a. At this moment, the pressing element 40a and the moving element 30a are both moving in the outward direction 81a, but the movement speed of the pressing element 40a is less than or equal to the movement speed of the moving element 30a. Therefore, the first contact elements 42a do not yet push upward against the second contact elements 32a. Thus the moving element 30a does not yet move in the upward direction 83.

When the rotation element 20a rotates in the first rotation direction 91 to a certain angle, the latching mechanism of an airtight container 1a will be in a position shown in FIG. 7. The path of the second guide 62 causes the speed at which the pressing element 40a moves in the outward direction 81a to be higher than the speed at which the moving element 30 moves in the outward direction 81. Because the first contact elements 42a and the second contact elements 32a are in a staggered arrangement, the first contact elements 42a exert an upward force on the moving element 30a. The moving element 30a then moves in the upward direction 83. The extremity 33a of the moving element 30a exerts pressure on the airtight container in the upward direction 83, which forms an airtight seal in the airtight container.

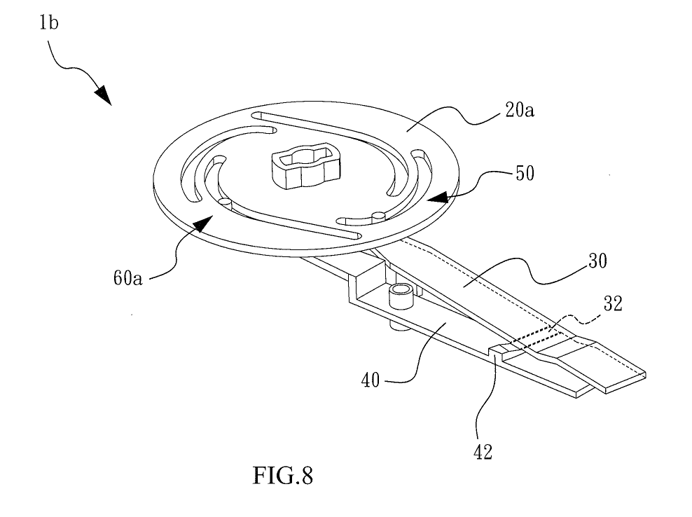

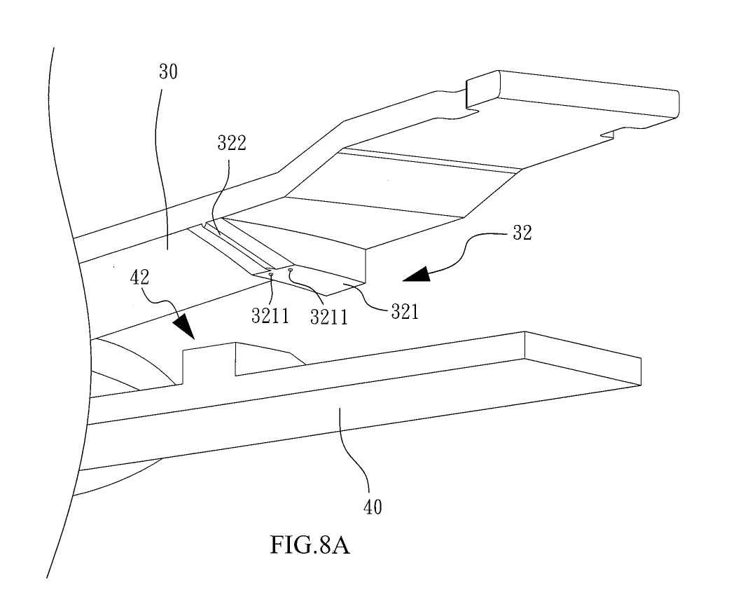

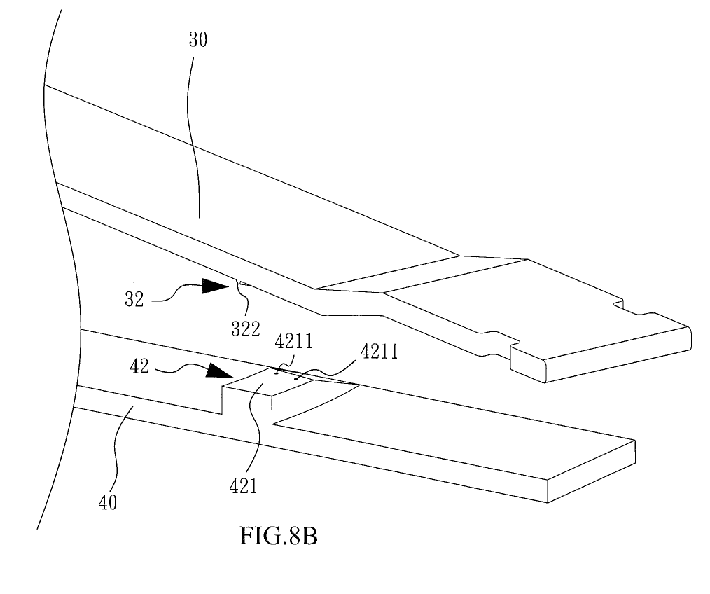

Please refer to FIG. 8, which presents a perspective view of the latching mechanism for an airtight container of a third embodiment of the present invention. The latching mechanism for an airtight container 1b comprises the door body 10, a rotation element 20a, a moving element 30, a second contact element 32, a first push mechanism 50, a pressing element 40, a first contact element 42, and a second push mechanism 60a.

In this embodiment, part of structure of the latching mechanism for an airtight container 1b is similar to the structure of the first embodiment. The other part of structure is similar to the structure of the second embodiment. More specifically, the structure of the rotation element 20a is similar to that of the second embodiment. The structure of the moving element 30, second contact element 32, and first push mechanism 50 is similar to that of the first embodiment. The structure of the pressing element 40 and the first contact element 42 is similar to that of the first embodiment. The second push mechanism 60a is similar to that of the second embodiment. This embodiment can also achieve the same result as the first and second embodiments, so the detailed structure and operation will not be elaborated upon.

Please refer to FIG. 8, FIG. 8A, and FIG. 8B. FIG. 8A and FIG. 8B are detailed drawings illustrating a first contact element and a second contact element of the latching mechanism of an airtight container of the third embodiment of the present invention. In this embodiment, the first contact element 42 further comprises a first plane 421. The second contact element 32 further comprises a second plane 321. The first contact element 42 slides relatively to the second contact element 32 until the first plane 421 contacts the second plane 321. When the first plane 421 contacts the second plane 321, the latching mechanism for an airtight container 1b is in a stable latched state.

In this embodiment, the first plane 421 further comprises at least one positioning indentation 4211. The second plane 321 further comprises at least one positioning protrusion 3211. When the positioning indentation 4211 contacts the positioning protrusion 3211, the effect of positioning can be produced. This generates a displacement restriction mechanism. When the latching mechanism for an airtight container 1b moves to the end position, the displacement restriction mechanism prevents the latching mechanism for an airtight container 1b from moving and causing a problem with interface compatibility during the reloading process due to the conveyance of the wafer pod or vibration. It should be noted that in this embodiment, the at least one positioning indentation 4211 and the at least one positioning protrusion 3211 are, respectively, two indented points and two protruding points. However, the shape and number of the positioning indentations 4211 and the positioning protrusions 3211 are not limited to this. Moreover, it should be noted that the positioning indentations 4211 and the positioning protrusions 3211 can be swapped; that is to say, the first plane 421 comprises at least one positioning protrusion, and the second plane 321 comprises at least one positioning indentation.

Furthermore, in this embodiment, the second contact element 32 further comprises a protruding portion 322. For example, the protruding portion 322 can be a rib strip or a plurality of protruding points. When the protruding portion 322 of the second contact element 32 contacts the first contact element 42, due to the decrease in the contact area, the friction area resulting from the relative sliding between the first contact element 42 and the second contact element 32 will be reduced, such that fewer dust particles will be produced. It should be noted that the protruding portion 322 can also be positioned at the first contact element 42.

The structures of the first plane 421, the second plane 321, the positioning indentation 4211, the positioning protrusion 3211, and the protruding portion 322 of the third embodiment can also be applied to other embodiments.

It is noted that the above-mentioned embodiments are only for illustration. It is intended that the present invention cover modifications and variations of this invention provided they fall within the scope of the following claims and their equivalents. Therefore, it will be apparent to those skilled in the art that various modifications and variations can be made to the structure of the present invention without departing from the scope or spirit of the invention.

What is claimed is:

1. A latching mechanism for an airtight container, comprising:
a door body;
a rotation element pivoting the door body, the rotation element rotating in a first rotation direction or a second rotation direction;
a moving element, the moving element moving in an outward direction or an inward direction;
a first push mechanism, wherein when the rotation element rotates in the first rotation direction, the first push mechanism makes the moving element move in the outward direction, the first push mechanism comprising:
a first guide slot situated at the rotation element; and
a first guide block situated at the moving element, the first guide block sliding within the first guide slot;
a pressing element situated at the door body; and
a second push mechanism, wherein when the rotation element rotates in the first rotation direction, the second push mechanism pushes the pressing element such that the pressing element pushes the moving element in an upward direction.

2. The latching mechanism of an airtight container as claimed in claim 1, further comprising at least one first contact element and at least one second contact element, wherein the first contact element is situated at the pressing element, and the second contact element is situated at the moving element; when the rotation element rotates in the first rotation direction, the second push mechanism pushes the pressing element, such that the first contact element pushes the second contact element in the upward direction.

3. The latching mechanism of an airtight container as claimed in claim 2, wherein the pressing element pivots the door body, and the second push mechanism comprises a first track and a second track, wherein the first track is positioned at the edge of the rotation element, and the second track is positioned at the edge of the pressing element; when the rotation element rotates in the first rotation direction, the first track contacts the second track such that the pressing element rotates.

4. The latching mechanism of an airtight container as claimed in claim 3, wherein the rotation direction of the pressing element is opposite to the rotation direction of the rotation element.

5. The latching mechanism of an airtight container as claimed in claim 4, wherein the first contact element is an elongated arc-shaped incline.

6. The latching mechanism of an airtight container as claimed in claim 2, wherein the first contact element further comprises a first plane, and the second contact element further comprises a second plane.

7. The latching mechanism of an airtight container as claimed in claim 6, wherein the first plane comprises at least one positioning indentation, and the second plane comprises at least one positioning protrusion.

8. The latching mechanism of an airtight container as claimed in claim 6, wherein the first plane comprises at least one positioning protrusion, and the second plane comprises at least one positioning indentation.

9. The latching mechanism of an airtight container as claimed in claim 2, wherein the first contact element or the second contact element further comprises a protruding portion.

10. The latching mechanism of an airtight container as claimed in claim 9, wherein the protruding portion is a rib strip or a plurality of protruding points.

11. The latching mechanism of an airtight container as claimed in claim 2, wherein the second push mechanism comprises a second guide slot and a second guide block, wherein the second guide slot is situated at the rotation element, and the second guide block is situated at the pressing element; when the rotation element rotates in the first rotation direction, the second guide block slides within the second guide slot such that the pressing element moves in the outward direction.

12. The latching mechanism of an airtight container as claimed in claim 11, wherein the first contact element is positioned on a side of the moving element, and the second contact element is positioned on a side of the pressing element, and a cross-section of the first contact element or the second contact element is triangular or trapezoidal.

13. The latching mechanism of an airtight container as claimed in claim 11, wherein the second guide slot is situated on the inside of the first guide slot.

14. The latching mechanism of an airtight container as claimed in claim 3, wherein the number of the at least one first contact elements is two, and the number of the at least one second contact elements is two.

15. The latching mechanism of an airtight container as claimed in claim 14, wherein when the pressing element pushes the moving element in the upward direction, the pressing element and the moving element are substantially parallel.

16. The latching mechanism of an airtight container as claimed in claim 3, wherein when the pressing element pushes the moving element in the upward direction, the pressing element and the moving element form an included angle.

17. The latching mechanism of an airtight container as claimed in claim 3, wherein the first guide slot is an eccentric arc, and the first guide block is a cylinder.

18. The latching mechanism of an airtight container as claimed in claim 11, wherein the second guide slot is an eccentric arc, and the second guide block is a cylinder.

19. The latching mechanism of an airtight container as claimed in claim 2, wherein the first contact element and the second contact element are wedge-shaped.

20. The latching mechanism of an airtight container as claimed in claim 11, wherein the number of the at least one first contact elements is two, and the number of the at least one second contact elements is two.
